(19) United States
(12) Patent Application Publication
(10) Pub. No.: US 2015/0227605 A1
(43) Pub. Date: Aug. 13, 2015

(54) INFORMATION PROCESSING TERMINAL, SYNCHRONIZATION CONTROL METHOD, AND COMPUTER-READABLE RECORDING MEDIUM

(71) Applicant: FUJITSU LIMITED, Kawasaki-shi (JP)

(72) Inventors: Masatoshi Kimura, Kawasaki (JP); Shin Yamada, Shiojiri (JP); Kohichi Kasama, Shizuoka (JP); Toshiyuki Kawanishi, Kawasaki (JP)

(21) Appl. No.: 14/694,596

(22) Filed: Apr. 23, 2015

Related U.S. Application Data
(63) Continuation of application No. PCT/JP2012/077655, filed on Oct. 25, 2012.

(51) Int. Cl. G06F 17/30

(52) U.S. Cl. CPC G06F 17/30581; G06F 17/30864; G06F 17/30365

(57) ABSTRACT

An information processing terminal includes a processor configured to execute a process. The process includes sharing, first storing, second storing, acquiring, and synchronizing. The sharing includes sharing a storage device with other information processing terminals in an information processing system that synchronizes data among the storage device and all of the information processing terminals. The first storing includes storing data and update information indicating whether the data is updated after synchronization. The second storing includes storing a latest date and time at which the data stored and data stored in the storage device are synchronized. The acquiring includes acquiring a latest date and time at which the storage device is synchronized with any of the information processing terminals when synchronizing data. The synchronizing includes synchronizing, when the latest date and time acquired and the latest date and time stored match each other, with the storage device, the data.

### CROSS-REFERENCE TO RELATED APPLICATION

This application is a continuation of International Application No. PCT/JP2012/077655, filed on Oct. 25, 2012 and designating the U.S., the entire contents of which are incorporated herein by reference.

### FIELD

The embodiments discussed herein are related to an information processing terminal, a synchronization control method, and a computer-readable recording medium.

### BACKGROUND

In recent years, cloud systems are in widespread use, and various services are provided to users via a network, such as the Internet. For example, in a cloud system, a plurality of physical servers and virtual machines that run on the physical servers are operated in a data center or the like. A client terminal accesses a server operating in the data center and receives various services to be provided.

As an example of the services to be provided, a cloud storage service is known. In the cloud storage service, a storage capacity provided by the service is limited for each user, and each user is allowed to freely store data within the capacity.

Non Patent Document 1: “ib on the net”, [online], searched on Oct. 16, 2012, Internet (URL: http://www.ibonthenet.com/ns/)

However, a single user normally uses a cloud system through a plurality of terminals, and the user updates data and uploads the data to the cloud system through each of the terminals. Therefore, it is difficult to synchronize the data.

In general, data is stored in a storage provided by cloud, and the same data as the data stored in the storage is also locally stored in each of the terminals used by the user. The user updates local data by each of the terminals and uploads the updated data to the storage.

Further, in the cloud storage service as described above, in some cases, each of the terminals may automatically perform synchronization upon being connected to the storage. In this case, old data is overwritten and updated with new data simply based on the chronological order of date and time of update, so that data being updated by the terminal or non-synchronized data stored in the terminal may be discarded. Further, it may be possible to control a synchronization process on a cloud side; however, this method is not preferable because a processing load on the cloud side increases with an increase in the number of users or the number of terminals used by each of the users, and overall processing performance is degraded.

### SUMMARY

According to an aspect of the embodiments, an information processing terminal includes: a processor configured to execute a process including: sharing a storage device on a network with other information processing terminals in an information processing system that synchronizes data among the storage device and all of the information processing terminals; first storing data and update information indicating whether the data is updated after synchronization with the storage device, in an associated manner; second storing a latest date and time at which the data stored at the first storing and data stored in the storage device are synchronized with each other; acquiring, from the storage device, a latest date and time at which the storage device is synchronized with any of the information processing terminals when synchronizing data with the storage device; and synchronizing, when the latest date and time acquired at the acquiring and the latest date and time stored at the second storing match each other, with the storage device, data whose update information is updated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a cloud system according to a first embodiment;

FIG. 2 is a diagram illustrating an example of processing target data;

FIG. 3 is a functional block diagram illustrating a configuration of an information processing terminal;

FIG. 4 is a diagram illustrating an example of an individual management file stored in an individual management file DB;

FIG. 5 is a diagram illustrating an example of an integrated management file stored in an integrated management file DB;

FIG. 6 is a flowchart illustrating the flow of a synchronization process;

FIG. 7 is a diagram for explaining a specific example of synchronization;

FIG. 8 is a diagram illustrating a software configuration;

FIG. 9 is a diagram illustrating a hardware configuration of a smartphone; and

FIG. 10 is a diagram illustrating a hardware configuration of a personal computer.

### DESCRIPTION OF EMBODIMENTS

Preferred embodiments will be explained with reference to accompanying drawings. The disclosed technology is not limited to the embodiments below.

### [a] First Embodiment

### Overall Configuration Diagram

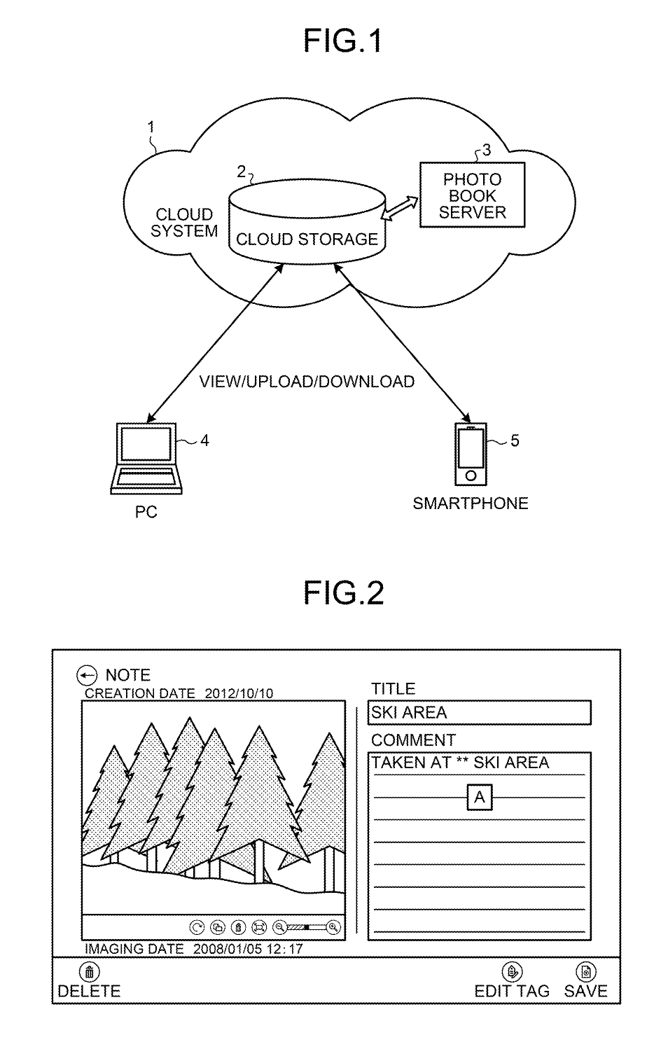

FIG. 1 is a diagram illustrating an overall configuration example of a cloud system according to a first embodiment. The overall configuration diagram described herein is an example, and the number of terminals and the like are not limited thereto. As illustrated in FIG. 1, a cloud system 1 includes a cloud storage 2, a photo book server 3, and information processing terminals, such as a personal computer (PC) 4 and a smartphone 5, used by a single user.

The cloud system 1 provides the user with a service to generate a photo book from image data stored in the cloud storage 2 by using the photo book server 3. The user stores image data in the cloud storage 2 by using the PC 4 or the smartphone 5 in which a cloud storage application is installed. An example of processing target data stored in the cloud storage 2 will be described below.

FIG. 2 is a diagram illustrating an example of the processing target data. As illustrated in FIG. 2, the processing target data contains a photograph or an image to which a title and a comment are added. The photograph or the image is an image or the like selected by the user from among pieces of image data captured by a digital camera or the like. The title is a title added to the selected image data by the user. The comment is a memory or the like of the image data input by the user. In the embodiments described below, the processing target data illustrated in FIG. 2 is described as a note.

The cloud storage 2 is a storage device or a server device that allocates a certain capacity to each of users who use the cloud system 1, and receives and stores a note from an information processing terminal used by each of the users. The photo book server 3 is a server device that binds notes stored in the cloud storage 2 into a book to generate a photo book.

The PC 4 and the smartphone 5 are examples of the information processing terminals used by a single user, and generate notes by activating the cloud storage applications or the like. The PC 4 and the smartphone 5 store the notes in the cloud storage 2 by using filer applications. Further, the PC 4 and the smartphone 5 view the notes in the cloud storage 2 and download the notes from the cloud storage 2 by using the filer applications.

In the cloud system 1, the cloud storage 2, the PC 4, and the smartphone 5 store the same note. Further, each of the PC 4 and the smartphone 5 updates a locally-stored note, and uploads the updated note to the cloud storage 2. Therefore, the cloud storage 2, the PC 4, and the smartphone 5 synchronize the note.

In this state, the information processing terminal stores therein image data and update information indicating whether the image data is updated after synchronization with the cloud storage 2, in an associated manner. Further, the information processing terminal stores therein a latest date and time at which the image data stored therein and data stored in the cloud storage 2 are synchronized with each other. When synchronizing image data with the cloud storage 2, the information processing terminal acquires, from the cloud storage 2, a latest date and time at which the cloud storage 2 is synchronized with any of the information processing terminals. Thereafter, if the latest date and time acquired from the cloud storage 2 and the locally-stored latest synchronization date and time match each other, the information processing terminal synchronizes, with the cloud storage 2, data whose update information is updated.

In this manner, when synchronizing image data in the cloud storage with local data, if the latest synchronization date and time managed by own terminal matches the latest synchronization date and time managed on the cloud side, the information processing terminal performs synchronization. Consequently, it is possible to accurately synchronize data among a plurality of terminals.

### Configuration of Information Processing Terminal

Next, a configuration of the information processing terminal will be described. The PC 4 and the smartphone 5 perform the same processes, and therefore are collectively described as an information processing terminal 10 below.

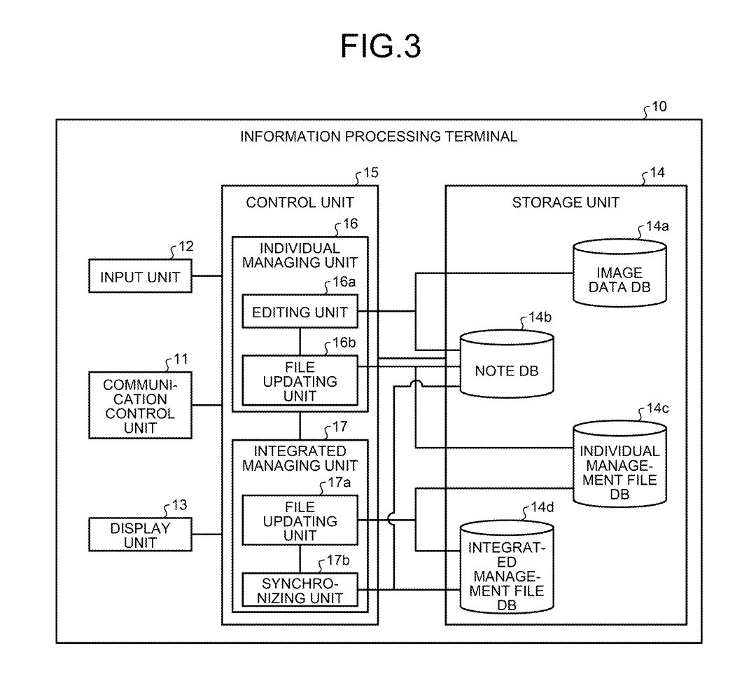

FIG. 3 is a functional block diagram illustrating a configuration of the information processing terminal. As illustrated in FIG. 3, the information processing terminal 10 includes a communication control unit 11, an input unit 12, a display unit 13, a storage unit 14, and a control unit 15.

The communication control unit 11 is a communication interface, such as a network interface card or a wireless interface. For example, the communication control unit 11 establishes communication with the cloud storage 2, and transmits and receives a note.

The input unit 12 is an input device, such as a mouse or a keyboard. For example, the input unit 12 receives operation input, such as characters, from a user, and inputs a document or the like in a title or a comment of a note. The display unit 13 is a display device, such as a display or a touch panel. For example, the display unit 13 displays a note creation screen or a note edit screen activated on the cloud storage application or the like.

The storage unit 14 is a storage device, such as a memory or a hard disk. The storage unit 14 stores therein an image data database (DB) 14a, a note DB 14b, an individual management file DB 14c, and an integrated management file DB 14d. The image data DB 14a is a database for storing image data, such as a photograph, an image, or a moving image, attached to a note. The image data stored here corresponds to data read from a digital camera or the like by the control unit 15 or the like.

The note DB 14b is a database for storing a note. For example, the note DB 14b stores therein a note and an identifier for identifying the note in an associated manner. The note stored in this DB is stored in the cloud storage 2 and to be synchronized among apparatuses.

The individual management file DB 14c is a database for storing a management file for managing each of notes stored in the note DB 14b. Incidentally, the cloud storage 2 stores therein the same information as an individual management file stored in each of the information processing terminals.

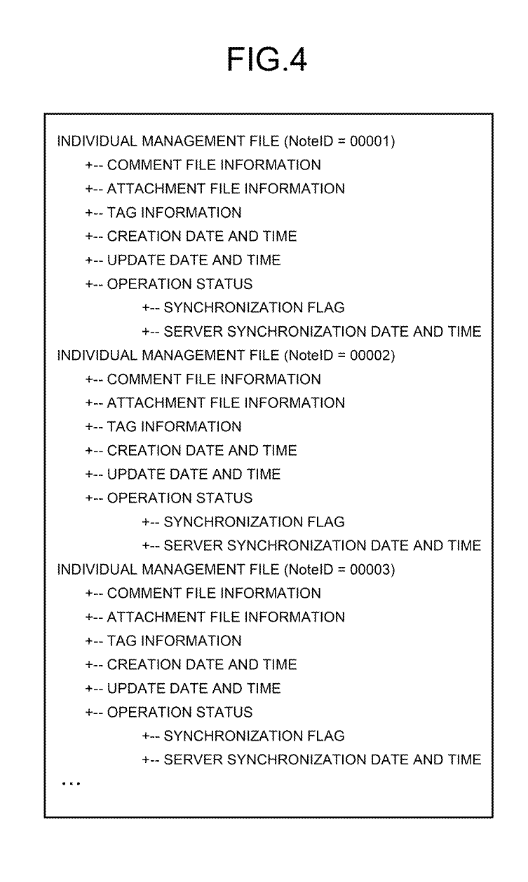

FIG. 4 is a diagram illustrating an example of the individual management file stored in the individual management file DB. As illustrated in FIG. 4, the individual management file DB 14c stores therein an individual management file for each note ID for identifying a note.

Each of the individual management files stores therein comment file information, attachment file information, tag information, a creation date and time, an update date and time, and an operation status. The comment file information is the content of a comment, a title, or the like contained in the note. The attachment file information is information for specifying image data attached to the note.

The tag information is a keyword or the like for searching for the note. The creation date and time is a date and time at which the note is created. The update date and time is a date and time at which the note is updated. The operation status contains a synchronization flag and a server synchronization date and time for managing a state of the note. The synchronization flag manages whether synchronization is performed after the note has been updated, and, “synchronized” is stored when the synchronization is performed and “non-synchronized” is stored when the synchronization is not performed. The server synchronization date and time is a date and time at which synchronization with the cloud storage 2 is performed, and is a date and time acquired from the cloud storage 2 at the time of synchronization.

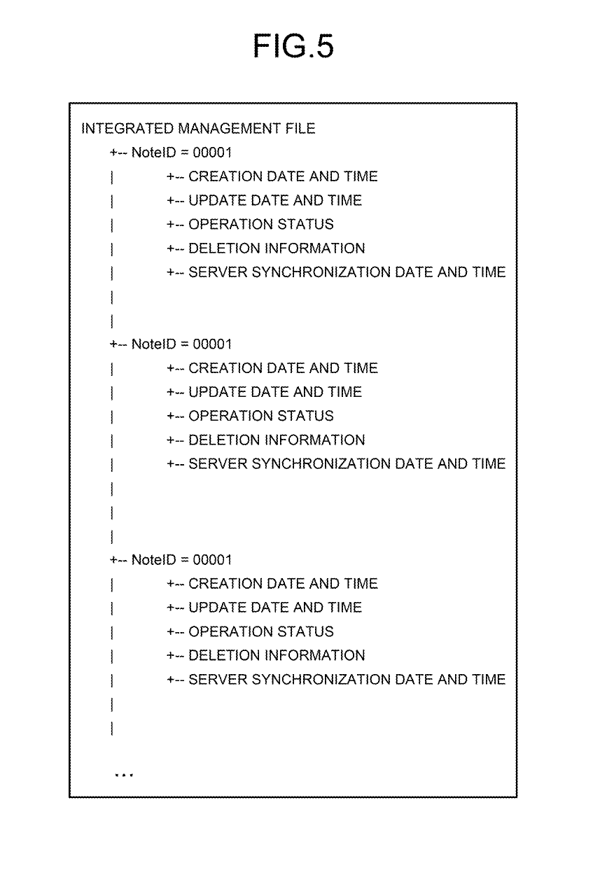

The integrated management file DB 14d is a database for managing a state of each of the individual management files. FIG. 5 is a diagram illustrating an example of an integrated management file stored in the integrated management file DB. As illustrated in FIG. 5, the integrated management file DB 14d stores therein a creation date and time, an update date and time, an operation status, deletion information, and a server synchronization date and time for each individual management file specified by the note ID.

The creation date and time is a date and time at which the individual management file is created. The update date and time is a date and time at which the individual management file is updated. The operation status is information indicating whether the individual management file is synchronized, that is, whether an edited note is synchronized. The deletion information is information indicating whether the individual management file is deleted, that is, whether the note is deleted. The server synchronization date and time is a date and time at which synchronization with the cloud storage 2 is performed, and is a date and time acquired from the cloud storage 2 at the time of synchronization.

The control unit 15 is a processing unit that includes an individual managing unit 16 and an integrated managing unit 17, and performs synchronization of a note with the cloud storage 2 by these units. For example, the control unit 15 is an electronic circuit, such as a processor.

The individual managing unit 16 is a processing unit that includes an editing unit 16a and a file updating unit 16b, and manages update of a note and update of an individual management file stored in the individual management file DB 14c by these units.

The editing unit 16a is a processing unit that receives an operation instruction from a user through the input unit 12 or the like, and performs new creation, update, deletion of a note. For example, upon receiving instruction operation from a user through the input unit 12 or the like, the editing unit 16a activates an application and displays a note edit screen on the display unit 13. Then, the editing unit 16a reads corresponding image data from the image data DB 14a, attaches the image data to a note, and creates a title or a comment of the note. The editing unit 16a assigns a unique identifier to the created note, and stores the note in the note DB 14b.

Further, the editing unit 16a reads a corresponding note from the note DB 14b in accordance with user operation, and performs various kinds of editing. For example, the editing unit 16a replaces image data, edits a title or a comment, or deletes a note itself.

The file updating unit 16b is a processing unit that updates an individual management file corresponding to an edited note based on note editing operation performed by the editing unit 16a. For example, when a note with a NoteID=00001 is newly created, the file updating unit 16b creates an individual management file of the note in the individual management file DB 14c, and sends a notice to the integrated managing unit 17. At this time, the file updating unit 16b stores a creation date and time in the creation date and time of the individual management file, stores a comment added to the note in the comment file information, and stores information on attached image data in the attachment file information. Similarly, the file updating unit 16b stores tag information added to the note in the tag information of the individual management file. The above described processes are performed in the same manner when a note is updated.

In the case of an update process, when a note stored in the note DB 14b is edited, the file updating unit 16b updates the update date and time of the individual management file and updates the operation status with “non-synchronized”, in addition to the above described processes. Then, the file updating unit 16b notifies the integrated managing unit 17 that the individual management file is updated. If a note stored in the note DB 14b is deleted, the file updating unit 16b notifies the integrated managing unit 17 that the individual management file is deleted.

The integrated managing unit 17 is a processing unit that includes a file updating unit 17a and a synchronizing unit 17b, and updates an integrated management file stored in the integrated management file DB 14d by these units.

The file updating unit 17a is a processing unit that updates an integrated management file in accordance with an update status of an individual management file received from the individual managing unit 16. Specifically, when being notified by the individual managing unit 16 that the individual management file of the note with the NoteID=00001 is created, the file updating unit 17a creates information on the NoteID=00001 in the integrated management file and sets a creation date and time. Further, when being notified by the individual managing unit 16 that the individual management file of the note with the NoteID=00001 is updated, the file updating unit 17a updates an update date and time of the NoteID=00001 in the integrated management file. Furthermore, when being notified by the individual managing unit 16 that the individual management file of the note with the NoteID=00001 is deleted, the file updating unit 17a updates deletion information on the NoteID=00001 in the integrated management file. Moreover, when creation, update, or deletion as described above is performed, the file updating unit 17a updates the operation status of a corresponding note with “non-synchronized”.

Furthermore, when the synchronizing unit 17b performs synchronization of notes, the file updating unit 17a updates the operation status of each of the individual management files managed by the integrated management file with “synchronized”. Thereafter, the file updating unit 17a sends an instruction to change the operation status of each of the individual management files to “synchronized” to the file updating unit 16b of the individual managing unit 16. The file updating unit 16b of the individual managing unit 16 that has received the change instruction changes the operation status of each of the individual management files to “synchronized”.

The synchronizing unit 17b is a processing unit that performs synchronization of a note with the cloud storage 2. Specifically, when synchronizing a note with the cloud storage 2, the synchronizing unit 17b acquires, from the cloud storage 2, a latest synchronization date and time at which the cloud storage 2 is synchronized with any of the information processing terminals. Then, if the latest synchronization date and time acquired from the cloud storage 2 matches the latest synchronization date and time managed by the integrated management file DB 14d, the synchronizing unit 17b synchronizes, with the cloud storage 2, a note whose operation status is updated.

Operation in the cases where an individual management file is updated in an online state and in an offline state will be described below. Online indicates a case in which the cloud storage 2 and the information processing terminal 10 are connected to each other.

In the case of online, when being notified by the individual managing unit 16 that the individual management file with the NoteID=00001 is updated, the file updating unit 17a updates the operation status of the NoteID=00001 with “non-synchronized”. The synchronizing unit 17b detects that the operation status is updated, and acquires the latest synchronization date and time managed by the cloud storage 2. Then, the synchronizing unit 17b determines whether the latest synchronization date and time in the cloud storage 2 matches each of the server synchronization dates and times in the integrated management file.

If the above described two latest synchronization dates and times match each other, the synchronizing unit 17b determines that the note in the cloud storage 2 has been synchronized with the note in the own terminal. Therefore, the synchronizing unit 17b uploads the note with the operation status of “non-synchronized” in the integrated management file, that is, the note updated locally, to the cloud storage 2.

In contrast, if there is a note that does not match the synchronization date and time of the cloud storage 2, the synchronizing unit 17b determines that the note in the cloud storage 2 has been synchronized with a note of a different terminal. Therefore, the synchronizing unit 17b copies the note with the operation status of “non-synchronized” in the integrated management file, that is, the note updated locally, to a temporary area or the like. Thereafter, the synchronizing unit 17b synchronizes the note in the cloud storage 2 with the note in the note DB 14b. At this time, if there is no note with the operation status of “non-synchronized” in the integrated management file, the synchronizing unit 17b does not perform a copying process or the like, and synchronizes the note in the cloud storage 2 with the note in the note DB 14b.

Meanwhile, it is assumed here that the note copied and saved in the temporary area or the like is a note with a “NoteID=001111”. When the note with the NoteID=001111 is to be updated after synchronization, the synchronizing unit 17b determines whether to use the note that has been copied in the temporary area before synchronization. Specifically, the synchronizing unit 17b determines whether the synchronized note is updated by using the note that has been copied before synchronization. If the note that has been copied before synchronization is not used for the update, the synchronizing unit 17b deletes the note that has been copied before synchronization. With this operation, it is possible to reduce an impact on the temporary area.

In contrast, in the case of offline, when being notified by the individual managing unit 16 that the individual management file with the NoteID=00001 is updated, the file updating unit 17a updates the operation status of the NoteID=00001 with “non-synchronized”. Then, the synchronizing unit 17b waits until the state is changed to online. Upon detecting online, the synchronizing unit 17b performs the above described processes. With this operation, even when a note is updated during offline, it is possible to manage the update status. Therefore, synchronization is automatically performed when the state is changed from offline to online, so that it is possible to prevent an already-updated note from being updated carelessly.

### Flow of Process

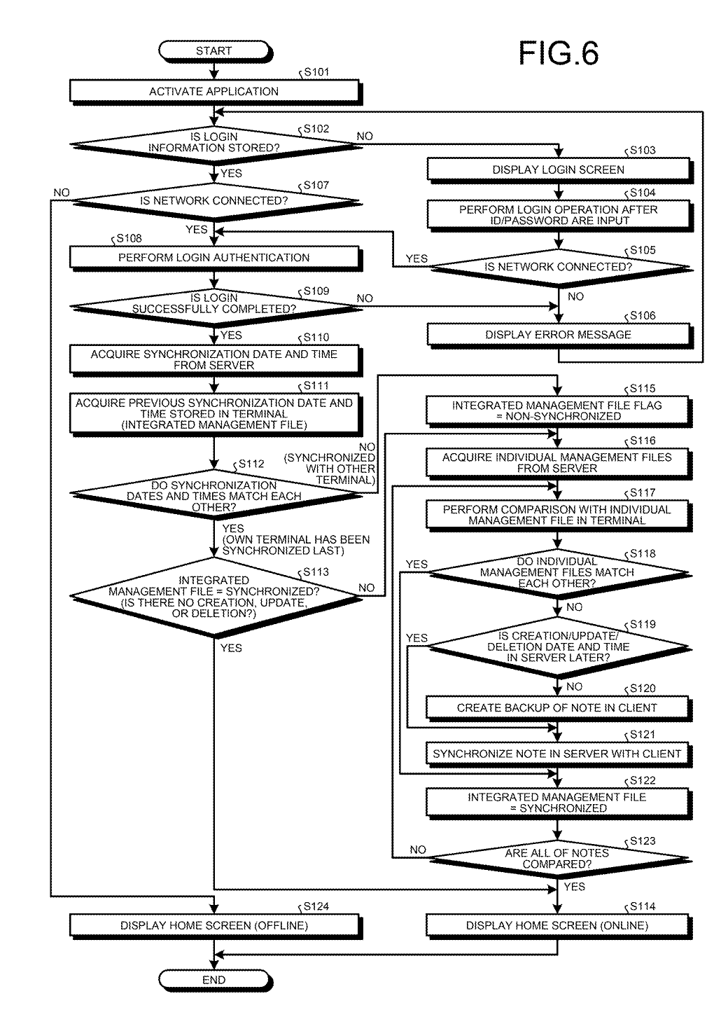

FIG. 6 is a flowchart illustrating the flow of a synchronization process. As illustrated in FIG. 6, upon receiving instruction operation from a user, the editing unit 16a of the information processing terminal activates a cloud storage application (Step S101), and determines whether login information is stored (Step S102).

When determining that the login information is not stored (NO at Step S102), the editing unit 16a displays a login screen on the display unit 13 (Step S103), and performs login operation of receiving input of an ID and a password (Step S104).

Subsequently, when a network is connected (YES at Step S105), that is, when the cloud storage 2 and the information processing terminal 10 are in a connected state, the editing unit 16a performs a process at Step S108. In contrast, when the network is not connected (NO at Step S105), that is, when the cloud storage 2 and the information processing terminal 10 are not in a connected state, the editing unit 16a displays an error message on the display unit 13 (Step S106). Thereafter, the editing unit 16a repeats processes from Step S102.

At Step S102, when determining that the login information is stored (YES at Step S102), the editing unit 16a determines whether the network is connected, that is, whether the cloud storage 2 and the information processing terminal 10 are in a connected state (Step S107).

When determining that the network is connected (YES at Step S107), the editing unit 16a performs login authentication (Step S108). If login fails (NO at Step S109), processes from Step S106 are performed.

In contrast, when the editing unit 16a determines that login is successfully completed (YES at Step S109), the synchronizing unit 17b acquires a latest synchronization date and time from the cloud storage 2 (Step S110). Then, the synchronizing unit 17b acquires a previous synchronization date and time stored in the information processing terminal 10 (Step S111). In this case, the synchronizing unit 17b acquires a server synchronization date and time of each of notes in the integrated management file. Incidentally, the synchronizing unit 17b may separately manage the latest synchronization date and time in the integrated management file.

If the latest synchronization date and time in the cloud storage 2 matches each of the server synchronization dates and times in the integrated management file (YES at Step S112), the synchronizing unit 17b determines whether the operation status of each of the notes in the integrated management file is set to “synchronized” (Step S113). Specifically, when determining that the own terminal is the last terminal that has been synchronized with the cloud storage 2, the synchronizing unit 17b determines whether there is an individual management file that is created, updated, or deleted after the synchronization.

When determining that the operation status of each of the notes in the integrated management file is set to “synchronized” (YES at Step S113), the synchronizing unit 17b displays an online home screen on the display unit 13 (Step S114). Specifically, if there is no note that is updated after the synchronization with the cloud storage 2, the synchronizing unit 17b terminates the process without performing synchronization.

In contrast, when determining that there is an individual management file with the operation status of “non-synchronized” in the integrated management file (NO at Step S113), the synchronizing unit 17b performs processes from Step S116. Specifically, when there is a note that is updated after the synchronization with the cloud storage 2, the synchronizing unit 17b performs synchronization.

In contrast, at Step S112, when determining that the latest synchronization date and time in the cloud storage 2 does not math any of the server synchronization dates and times in the integrated management file (NO at Step S112), the synchronizing unit 17b performs processes from Step S115.

Specifically, the synchronizing unit 17b sets the operation status of each of the individual management files in the integrated management file to “non-synchronized” (Step S115). Subsequently, the synchronizing unit 17b acquires, from the cloud storage 2, all of the individual management files stored in the cloud storage 2 (Step S116).

Then, the synchronizing unit 17b selects one of the acquired individual management files, acquires the selected individual management file and an individual management file with the same NoteID as that of the selected file in the integrated management file, and determines whether both of the files match each other by comparison (Step S117). Specifically, the synchronizing unit 17b determines whether the individual management file has been created, updated, or deleted.

When determining that both of the files do not match each other (NO at Step S118), the synchronizing unit 17b determines whether the creation date and time, the update date and time, or the deletion information in the cloud storage 2 is later (Step S119). Specifically, when the individual management file in either one of the cloud storage 2 and the integrated management file DB 14d has been updated, the synchronizing unit 17b determines which of the updates is later.

Subsequently, when determining that the update of the individual management file in the integrated management file DB 14d on the local side is later (NO at Step S119), the synchronizing unit 17b creates a backup of a note corresponding to the individual management file (Step S120).

Thereafter, the synchronizing unit 17b synchronizes the note specified by the individual management file in the cloud storage 2 with the note DB 14b (Step S121). Then, the file updating unit 17a updates the operation status corresponding to the synchronized note in the integrated management file DB 14d to “synchronized” (Step S122). In this case, the file updating unit 16b also updates the operation status corresponding to the note in the individual management file DB 14c to “synchronized”.

When completing the comparison and the synchronization process from Step S117 to Step S122 as described above on all of the notes (YES at Step S123), the synchronizing unit 17b performs a process at Step S114 and terminates the process. In contrast, if there is a note on which the comparison and the synchronization process from Step S117 to Step S122 as described above are not performed (NO at Step S123), the synchronizing unit 17b returns to the process at Step S117, and performs the processes from Step S117 on an individual management file of a next note.

Further, at Step S119, when determining that the update of the individual management file in the integrated management file DB 14d on the local side is older (YES at Step S119), the synchronizing unit 17b performs a process at Step S121 without taking a backup.

Furthermore, at Step S118, when determining that the individual management file in the cloud storage 2 matches the individual management file in the integrated management file DB 14d (YES at Step S118), the synchronizing unit 17b performs the process at Step S122.

Moreover, at Step S107, when determining that the network is not connected (NO at Step S107), the editing unit 16a displays an offline home screen on the display unit 13 (Step S124), and terminates the process.

### Specific Example

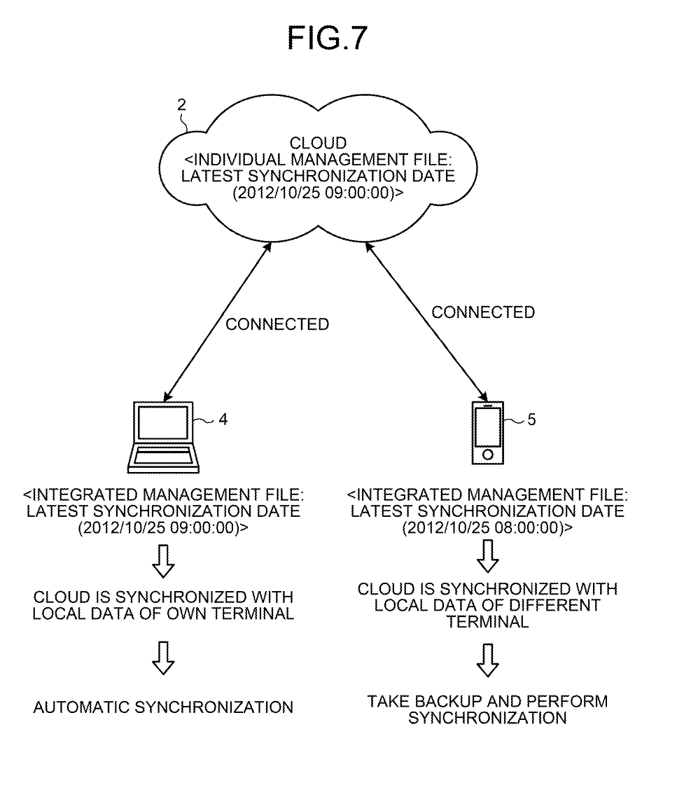

FIG. 7 is a diagram for explaining a specific example of synchronization. As illustrated in FIG. 7, a system including the cloud storage 2, the PC 4, and the smartphone 5 is illustrated by way of example. Further, each of the devices stores therein a note.

In this example, the cloud storage 2 stores therein “Oct. 25, 2012 09:00:00” in the individual management file, as the latest date and time at which synchronization of a note is performed with either one of the PC 4 and the smartphone 5.

In this state, the PC 4 acquires a latest synchronization date and time of “Oct.25, 2012 09:00:00” from the cloud storage 2 at a timing of connection to the cloud storage 2. Then, the PC 4 determines whether a latest synchronization date and time of “Oct.25, 2012 09:00:00” managed by the integrated management file in own terminal and the synchronization date and time of “Oct.25, 2012 09:00:00” acquired from the cloud storage 2 match each other.

In this example, the synchronization dates and times match each other; therefore, the PC 4 determines that own terminal is the last terminal that has been synchronized with the cloud storage 2, in particular, determines that the note in the cloud storage 2 is synchronized with the local data. Thereafter, the PC 4 performs normal automatic synchronization. For example, the PC 4 uploads a note updated with local data, that is, a note whose operation status is set to “non-synchronized” by being updated after synchronization with the cloud storage 2, to the cloud storage 2.

In contrast, the smartphone 5 acquires the latest synchronization date and time of “Oct.25, 2012 09:00:00” from the cloud storage 2 at a timing of connection to the cloud storage 2. Then, the smartphone 5 determines whether a latest synchronization date and time of “Oct.25, 2012 08:00:00” managed by the integrated management file of own terminal and the synchronization date and time of “Oct.25, 2012 09:00:00” acquired from the cloud storage 2 match each other.

In this example, the synchronization dates and times do not match each other; therefore, the smartphone 5 determines that a different terminal is the last terminal that has been synchronized with the cloud storage 2, in particular, determines that the note in the cloud storage 2 differs from the local data. Therefore, the smartphone 5 takes a backup of the note stored on the local side, and performs synchronization with the cloud storage 2.

### Advantageous Effects

As described above, in the cloud system 1, the integrated management file is provided on a client side, and a date and time of synchronization with cloud in the integrated management file is set to a date and time of the cloud side rather than a date and time of the client. Therefore, even when the date and time of the client varies, it is possible to perform synchronization with other terminals. Meanwhile, the information processing terminal illustrated in FIG. 1 is an example of the client. Further, on the client side, the individual management file contains a flag indicating “synchronized” or “non-synchronized” as the operation status in consideration of use in the offline state, and, when edit is performed in the offline state, “synchronized” is updated with “non-synchronized”, and an update date and time is stored.

The integrated management file of the client works when online communication with the cloud is enabled, and discriminates a difference in notes with respect to the cloud when the state is changed to the online state. Then, the client checks the operation status of the individual management file of the note containing the difference, and overwrites the note on the local side with the note in the cloud when the operation status is set to “synchronized”. In contrast, when the operation status is set to “non-synchronized”, the client determines that the note is old and there is a non-synchronized note, so that the client stores a backup of the note and overwrites the note on the local side with the note in the cloud.

As described above, when the information processing terminal is synchronized with cloud, it is possible to reduce a load on the cloud side, and prevent currently-updated data or non-synchronized edited data from being discarded at the time of synchronization. Therefore, it is possible to accurately synchronize data among terminals, each of which updates data in a shared storage.

### [b] Second Embodiment

While the embodiments of the disclosed technology have been explained above, the disclosed technology may be embodied in various forms other than the embodiments as described above. Therefore, other embodiments will be described below.

### Example of Information Processing Terminal

In the first embodiment, an example has been described in which a PC and a smartphone are taken as the examples of the information processing terminal; however, it is not limited thereto. For another example, a mobile phone, a digital camera or a video camera with a Wi-Fi function, a digital camera or a video camera in which a memory card with a Wi-Fi function is inserted, or the like may be employed. Further, while a note containing image data is synchronized in the embodiment, it is not limited thereto. For example, the same process is applicable to other data, such as text information or a moving image.

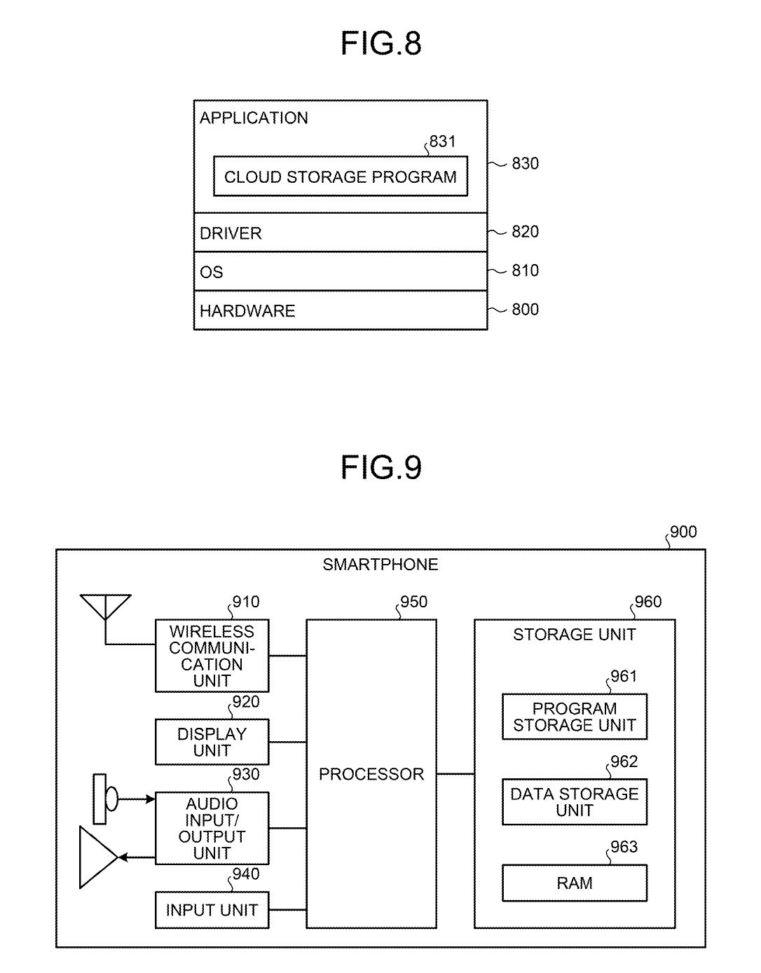

Next, a configuration of software that implements cooperation between the information processing terminal 10 and the cloud storage 2 will be described. FIG. 8 is a diagram illustrating a software configuration. As illustrated in FIG. 8, software for implementing cooperation between the information processing terminal 10 and the cloud storage 2 includes an operating system (OS) 810, a driver 820, and an application 830. The OS 810, the driver 820, and the application 830 implement a cooperation process in cooperation with hardware 800.

The driver 820 implements various functions related to external communication in the information processing terminal 10. The application 830 includes a cloud storage program 831. The cloud storage program 831 implements the same functions as those of each of the processing units included in the control unit 15 illustrated in FIG. 3. Further, the cloud storage program 831 cooperates with other information communication devices, such as the cloud storage 2, by using the driver 820.

### Hardware Configuration of Smartphone

FIG. 9 is a diagram illustrating a hardware configuration of a smartphone. As illustrated in FIG. 9, a smartphone 900 includes a wireless communication unit 910, a display unit 920, an audio input/output unit 930, an input unit 940, a processor 950, and a storage unit 960. The wireless communication unit 910, the display unit 920, the audio input/output unit 930, the input unit 940, and the storage unit 960 are connected to the processor 950.

The storage unit 960 includes a program storage unit 961, a data storage unit 962, and a random access memory (RAM) 963. The program storage unit 961 stores therein a program, such as the cloud storage program 831, for implementing the same functions as those of each of the processing units included in the control unit 15 illustrated in FIG. 3. The data storage unit 962 stores therein various kinds of data stored in each of the DBs illustrated in FIG. 3. Meanwhile, the storage unit 960 is a storage device, such as a semiconductor memory element including a RAM or a flash memory, a hard disk drive (HDD), or an optical disk.

The processor 950 is an integrated circuit, such as an application specific integrated circuit (ASIC) or a field programmable gate array (FPGA), or an electronic circuit, such as a central processing unit (CPU) or a micro processing unit (MPU). The processor 950 reads a program, such as the cloud storage program 831, from the storage unit 960, and loads the program onto the RAM 963. Accordingly, the program, such as the cloud storage program 831, functions as a process, such as a cloud storage process. Then, the cloud storage process appropriately loads information read from the data storage unit 962 or the like on an area allocated thereto in the RAM 963, and performs various kinds of data processing based on the loaded data or the like.

### Hardware Configuration of Personal Computer

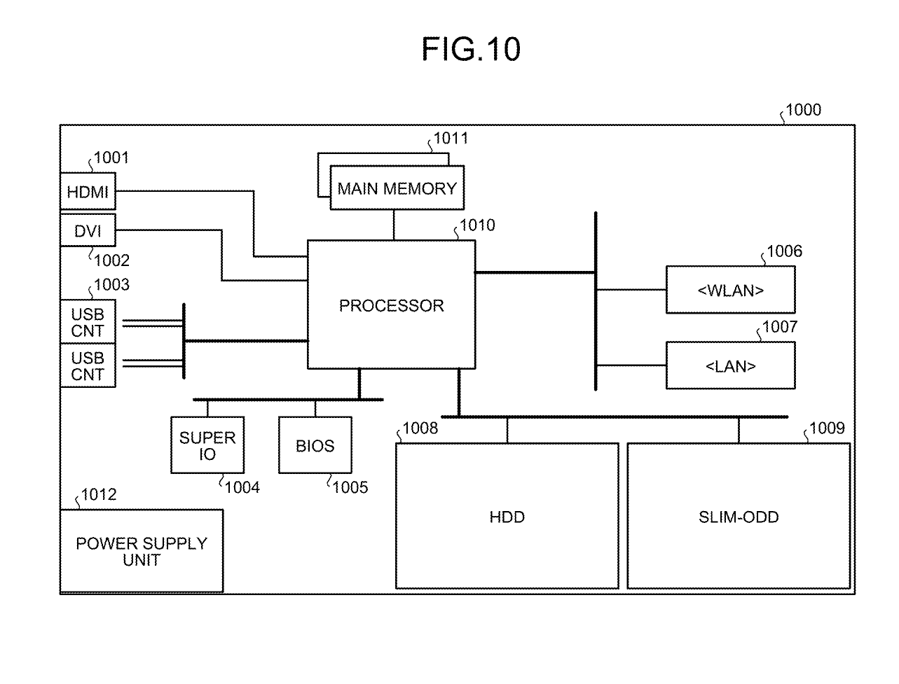

FIG. 10 is a diagram illustrating a hardware configuration of a PC. As illustrated in FIG. 10, a PC 1000 includes a processor 1010, and performs various processes by using various devices connected thereto.

Specifically, the processor 1010 is connected to a main memory 1011. The PC 1000 further includes a power supply unit 1012, and supplies electrical power to each hardware or the like.

The processor 1010 is connected to a High-Definition Multimedia Interface (HDMI) connector 1001 that outputs video and audio by digital signals. The processor 1010 is also connected to a digital visual interface (DVI) connector 1002 connected to the display or the like. With these devices, the processor 1010 outputs video and audio to an external apparatus.

The processor 1010 is connected to a plurality of universal serial bus (USB) connectors 1003. With this device, the processor 1010 is connected to an external storage device or the like, reads data from the external storage device or the like, and writes data to the external storage device.

The processor 1010 is connected to a basic input/output system (BIOS) 1005 or a super input/output 1004 by using a low pin count (LPC) bus. With these devices, the processor 1010 executes BIOS or controls input and output.

The processor 1010 is connected to a wireless local area network (WLAN) interface 1006 or a local area network (LAN) port 1007 via a Peripheral Components Interconnect bus Express (PCIe). The processor 1010 performs wireless communication or wired communication by using these devices. Meanwhile, the PC 1000 is enabled to perform communication in the same manner through wireless communication or wired communication with the cloud storage 2 or other terminals.

The processor 1010 is connected to storage devices such as an HDD 1008 and a slim optical disk drive (slim-ODD) 1009 via a Serial AT Attachment (SATA). The storage devices store therein a program, such as the cloud storage program 831, for implementing the same functions as those of each of the processing units included in the control unit 15 illustrated in FIG. 3 or various kinds of data stored in each of the DBs illustrated in FIG. 3.

The processor 1010 reads the cloud storage program 831 from the storage device and loads the program to the main memory 1011, so that the cloud storage program 831 functions as the cloud storage process. The cloud storage process appropriately loads information read from the storage device on an area allocated thereto in the main memory 1011, and performs various kinds of data processing based on the loaded data or the like.

The above described cloud storage program 831 may be stored in other computer (or server) connected to the PC 1000 via a public line, the Internet, a LAN, a wide area network (WAN) or the like. In this case, the PC 1000 reads and executes the cloud storage program 831 from the other computer or the like through the network interface.

### System

Of the processes described in the embodiments, all or part of a process described as being performed automatically may be performed manually. Alternatively, all or part of a process described as being performed manually may also be performed automatically by known methods. In addition, the processing procedures, control procedures, specific names, and information including various kinds of data and parameters illustrated in the above-described document and drawings may be arbitrarily changed unless otherwise specified.

The components of the apparatuses illustrated in the drawings are functionally conceptual and need not necessarily be physically configured in the manner illustrated in the drawings. That is, specific forms of distribution and integration of the apparatuses are not limited to those illustrated in the drawings. In other words, all or part of the apparatuses may be functionally or physically distributed or integrated in arbitrary units depending on various loads or use conditions. Further, for each processing function performed by each apparatus, all or any part of the processing function may be implemented by a CPU and a program analyzed and executed by the CPU or may be implemented as hardware by wired logic.

According to an information processing terminal, a synchronization control method, and a computer-readable recording medium of the disclosed technology, it is possible to accurately synchronize data among a plurality of terminals, each of which updates data in a shared storage.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing terminal comprising:
a processor configured to execute a process including:
sharing a storage device on a network with other information processing terminals in an information processing system that synchronizes data among the storage device and all of the information processing terminals;
first storing data and update information indicating whether the data is updated after synchronization with the storage device, in an associated manner;
second storing a latest date and time at which the data stored at the first storing and data stored in the storage device are synchronized with each other;
acquiring, from the storage device, a latest date and time at which the storage device is synchronized with any of the information processing terminals when synchronizing data with the storage device; and
synchronizing, when the latest date and time acquired at the acquiring and the latest date and time stored at the second storing match each other, with the storage device, data whose update information is updated.

2. The information processing terminal according to claim 1, wherein when the latest date and time acquired at the acquiring and the latest date and time stored at the second storing do not match each other and when there is the data whose update information is updated, the synchronizing includes saving the data whose update information is updated from a first storage to a different storage, and thereafter synchronizing the data stored in the storage device with the data stored at the first storing.

3. The information processing terminal according to claim 2, wherein when synchronized data being stored at the first storing as original data of the data saved in the different storage is to be edited after synchronization, and when the data saved in the different storage is not used for editing, the synchronizing includes deleting the data saved in the different storage from the different storage.

4. The information processing terminal according to claim 1, wherein when the latest date and time acquired at the acquiring and the latest date and time stored at the second storing do not match each other and when there is no updated data, the synchronizing includes synchronizing the data stored in the storage device with the data stored at the first storing.

5. A synchronization control method comprising:
sharing a storage device on a network with other information processing terminals in an information processing system that synchronizes data among the storage device and all of the information processing terminals, by a processor;
acquiring, from the storage device, a latest date and time at which the storage device is synchronized with any of the information processing terminals when synchronizing data stored in a first storage with the storage device, by the processor; and
synchronizing, with the storage device, data whose update information, which is stored in the first storage in association with the data and which indicates whether the data is updated after synchronization with the storage device, is updated when the latest date and time acquired at the acquiring and a latest date and time, which is stored in a second storage in association with the data stored in the first storage and which indicates a latest date and time of the synchronization with the storage device, match each other, by the processor.

6. A non-transitory computer-readable recording medium storing a synchronization control program that causes a computer to execute a process comprising:
sharing a storage device on a network with other information processing terminals in an information processing system that synchronizes data among the storage device and all of the information processing terminals;
acquiring, from the storage device, a latest date and time at which the storage device is synchronized with any of the information processing terminals when synchronizing data stored in a first storage with the storage device; and
synchronizing, with the storage device, data whose update information, which is stored in the first storage in association with the data and which indicates whether the data is updated after synchronization with the storage device, is updated when the latest date and time acquired at the acquiring and a latest date and time, which is stored in a second storage in association with the data stored in the first storage and which indicates a latest date and time of the synchronization with the storage device, match each other.
